(19) United States
(12) Patent Application Publication
(10) Pub. No.: US 2004/0252594 A1
(43) Pub. Date: Dec. 16, 2004

(54) Digital image display device (DIDD)

(76) Inventor: Steven Charles Jewkes, Dublin, CA (US)

Correspondence Address: STEVE JEWKES, 6422 SHERWOOD PL, DUBLIN, CA, 94568, US

(21) Appl. No.: 10/443,714

(22) Filed: May 23, 2003

(51) Int. Cl. G11B 7/085; G11B 21/08

(52) U.S. Cl. 369/30.17

(57) ABSTRACT

Creation of the electronic invention is the result of an individual's natural progression to create a digital photo album from archived CDs containing digital photo images. The invention will only read images that are within an inserted CD. It will be approximately the size of a hand-held photo album. This simple electronic device will display only common formatted images that are on a CD (eg, jpg). A scroll feature will display any image on the CD. Displayed images on the product's screen can also be outputted to a television set. Output will be controlled by the invention. Product will also be rechargeable. Patent will explore necessary accessories based on function. Device will be autonomous; it will not be attached to a computer.

### CROSS-REFERENCE TO RELATED APPLICATIONS

Related Patents:

CD-ROM:

U.S. Pat. No. 5,067,128

U.S. Pat. No. 4,575,835

U.S. Pat. No. 4,937,803

U.S. Pat. No. 4,955,010

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Market is saturated by expensive, proprietary products that display (at best) a limited quantity of digital images in a device known as an electronic “picture frame”. Major manufacturers of digital cameras have created peripheral products that still largely cater to the printed image. The closest product that addresses a digital image with a digital display is this “picture frame”. These electronic devices capture a small quantity of digital images and display them by way of a couple of mediums. One is the memory card format. This format is less than the size of a floppy disk and stores a limited number of images in the common jpg format. It is not a common medium to transfer and store images. One has to learn and acclimate to a proficiency level for a product (line) that can only be used for that product (eg, Sony).

The same can be said of the other electronic display medium: a display directly connected to the internet through a standard USB port. Although this is a simpler method of image transfer, it is tied to the ISP. Kodak is now focusing on exclusive software to create photo albums that can be sent and distributed through the internet. Both of these options make the user dependent on the internet for storage/manipulation of perhaps gigs-worth of personal images.

Any image using either of these technologies (memory card, internet) cannot be easily manipulated. To edit/display an image between a digital camera/computer/“picture frame” is an exhausting, laborious task, whose result, through limited proprietary software, is a shadow of what the user actually wanted. Although the internet option has a smaller learning curve, it does place a sizable amount of personal information on the internet.

As a minor aside, a couple of software programs (Adobe Photoshop Album, Apple iphoto) offer virtual “albums” that are comprised of images arranged in an “album” format on your computer. These albums are sent via internet to another source to produce a tactile album, which is eventually sent to you by mail. Based on a recent Wall Street Journal article on the subject, the best of the two was the Apple iphoto 2. Although reasonably priced ($29.95—10 page album), Apple only has an approximate 12% share of a predominately Windows (IBM) market. A good product, but not many potential buyers.

The last paragraph raised a question of why still cater to the printed image? Kodak still makes a sizable profit on their prints as opposed to their digital products. The answer is that it is easier to see a print than it is to see a digital image. You can't really carry a digital photo, but you can carry a printed image anywhere. This invention will let you carry that digital photo anywhere; cheaply, effectively. Cost effective technology is already in place (laptops, LCDs, etc.); rearranging a few of their components to fit a different application is the basis for this invention.

### BRIEF SUMMARY OF THE INVENTION

The invention will: 1) Indirectly take advantage of the highly developed, currently available, “photo manipulation” software that has become standard for every desktop computer (Photo Print Shop, Windows Imaging, even Paint); 2) It will free the consumer not to be tied to a particular product line to view and store images, 3) There will be no learning curve for the consumer; this invention will just have two scroll buttons and an output.

Manipulation of an image inside a computer is easy. The home/personal computer has a vast array of software packages that can manipulate/edit these digital images (HP printer software, etc.). These software packages can assemble any array of images and create a computer file that resembles a photo album page (Photo Shop, HP printer software, etc.), complete with additional graphics to accent the photos.

Every major developer with these packages offers the ability to convert the individual's digital photo/creation into a common file format (eg, jpg). The jpg format is an example that offers a small file size and a high degree of “quality” information (eg, resolution). It has been around as long as Windows and will continue to be around long into the future (Kodak and others are creating “digital photo albums” that can be sent over the internet using this particular format).

Although I have a particular preference for the jpg format, it may not be the most common digital photo image in the future. Once a manufacturer has been designated, the invention will cater to the dominant format of that particular time period. For the sake of discussion though, this invention will read images on a CD that are in the jpg format.

Once the consumer creates a digital image, he or she will want to save it to a sub-directory on their personal/home computer. Saving an image is nothing new; within each graphics-type program, a “save as” option is almost always required before exiting a newly created computer file (image).

The next step would be to save this file (and others) onto the common 5-¼″ CD-R (Recordable). Although the market is plentiful of CD-R type CDs, the potential that a cheap, versatile re-recordable CD may saturate the market by the time this invention is produced. Either way, the invention will only be concerned with the recorded image; both types of CDs will work with this device. For the sake of discussion concerning the current market/technology, CD-R will be the choice of CD to be inserted into the invention.

The way to record an image onto a CD-R is accomplished through a CD-Write device, commonly known as a “CD Burner”. Although still considered an option (Dell), the not to distant future will have these devices an essential part of every computer. It should be recognized that Mom and Pop will eventually fill-up their home computer hard drive (HDD). Although currently the home computer can fill gigs-worth of information onto a HDD, this may be a short-term solution for storage. Graphics-filled photos, or composite images are byte-hungry files that chip huge chunks of a HDD. With those types of files, it wouldn't be difficult to fill a HDD, no matter how large its capacity.

Manufacturers will recognize these limitations of FIDD storage and give their customers the ability to burn old, important files onto a CD-R. CD Burners will become standard on every computer in the near future.

Manufacturers will also recognize the need to archive personal information (wills, taxes, personal information, etc.) regardless of HDD capacity. This just furthers the need to have a burner a part of every computer.

Burners are easy to use. Adaptec is one of the first programs to make it easy for one to “burn” a CD-R with a simple dialog box. The “box” contains “pictures” (icons) which indicate what kind of CD you want to burn (eg, an old phonograph depicts burning a music CD). After choosing the “photo” icon, all one has to do is follow the one sentence instructions. Typically, you select the pictures, drag them into the program, then just select “Create CD”.

Acknowledging that the near future will have standard file formats, burners will be easy to use, and the need for personal digital photo archives, it becomes easy to see the need for a simple device to display digital images. This invention will only read images stored (burned) on a 5-¼″ CD-R. It will be hand-held for easy mobility and viewing. The end user will only be required to A) place the CD-R onto the ejected CD tray and push the tray back into the DIDD, and B) push the forward/back keys on the front near the display. It will not be tied to a particular product line; it will just read commonly formatted images on a CD-R.

It should be mentioned that even though this product is primarily for a photo images, any type of image can be viewed in this device (artwork, scanned images, etc.); as long as it is a single computer file that is commonly-formatted.

The invention will have a rechargeable cord that can be plugged into a standard 110V outlet. The cord/unit will be similar to a cell phone/laptop “charger”. The invention will be able to be used for at least two hours (informal survey of laptop end users).

Old information from perhaps a few years ago (stored on a CD-R) can now be viewed easily and shared with others. One is now free to show pictures anywhere—without a computer.

Part of the intent of the product is to be cost effective. The target is for the invention to be cheaper than a laptop and about as expensive as a Personal Digital Assistant (PDA). The shear logic of a few simple components compared to the amount of a laptop should make for sound argument that it will be cheaper than a laptop. On the other hand, a cost comparable to a PDA requires a little more analysis:

PDA prices range from $100 (Palm) to $399 (Compac)

Digital Image Display Device:

| | |
|---|---|
| 1) CD-ROM | $34.00 |
| 2) B/W PDA-type LCD | $23.00 |
| 3) Packaging | $21.00 |
| 4) PCB | $4.00 |
| TOTAL: | $82.00 |

As one can see, these preliminary prices show a total that is even below a PDA. The pricing reflects prototype/initial production costs (quantities ranging from 4-1000). Prices will differ according to quantity manufactured. Labor to assemble DIDD was not part of this equation. Initial engineering development costs were also not included. Notice that a black and white PDA-type LCD was chosen (B/W). Unfortunately, a color version wasn't available for pricing. This may be a viable alternative if a color PDA-type LCD is too costly or not immediately available for the end user.

I feel this is a small price for the consumer to pay considering it will be the only photo album he/she will ever need.

Another feature that is a part of the invention (DIDD) is a connector receptacle for an output to a television set. This will give the user the ability to show photos on his/her television screen. With a universal plug and connector that is a part of every current television, one can view images like a slide show from the old days. Te possibilities for any type of presentation (school, business, even a homeowner association “slide show”) are possible with this added feature.

The previous paragraph alludes to a primary market that this product caters to. Baby Boomers are entering middle age without some of the nostalgic comforts they once had before the computer. For the majority of this population sector, the computer has been an unwelcomed tool. They have complained that the learning curve is very steep. Couple this with the old phobia that “computers are for smart people” and you have the nightmare that Apple tried to tackle by creating everything “user friendly”. The Baby Boomer generation is still the largest demographic in the country. They still have the primary purchasing power. It makes sense that new products should consider their needs.

The invention recognizes the need for the old family get-together and view grandma and grandpa's slide show. The simple output to the television addresses this. The invention also recognizes the need to show neighbors and friends at the town barbecue the perfect pictures you took in Europe. The hand-held, lightweight, DIDD can accomplish this easily. Tony can share his pictures with Steve at the barbecue by just pushing a button for forward or back.

This is an invention that will be a breath of fresh air for the consumer. It will allow one the freedom to share personal new/old memories with anyone/anywhere. The consumer will finally associate digital photos with the old slide show or the family album. It will not be complicated; it won't belong to an exclusive product line; it won't be tied to the internet. This product won't even depend on the computer; it will be separate from it.

It will truly be “user friendly”.

### BRIEF DESCRIPTION OF THE SEVERAL VIEWS OF THE DRAWING

FIG. 1 Travel case in closed position (accessory).

FIG. 2 Travel case in open position.

FIG. 3 Vertical Recharge Station (accessory). Stand for DIDD while charging.

FIG. 4 VRS with DIDD while charging.

FIG. 4A Wire shape to form “clip” for the recharge unit's male connector.

FIG. 5 General PCB layout.

FIG. 6 DIDD exploded view.

FIG. 7 Perspective showing actual use of the DIDD. Shown with the CD tray extended (closed when in use).

Appendix

FIG. 8 Mechanical CAD (design). Shows major component orientation. It should be noted that each component is drawn as if a separate entity.

FIG. 9 Mechanical CAD (design). Packaging design. Entities are drawn as if separate.

FIG. 10 Mechanical CAD (design). Overall design. Design showing all entities placed together.

### DETAILED DESCRIPTION OF THE INVENTION

Accessories

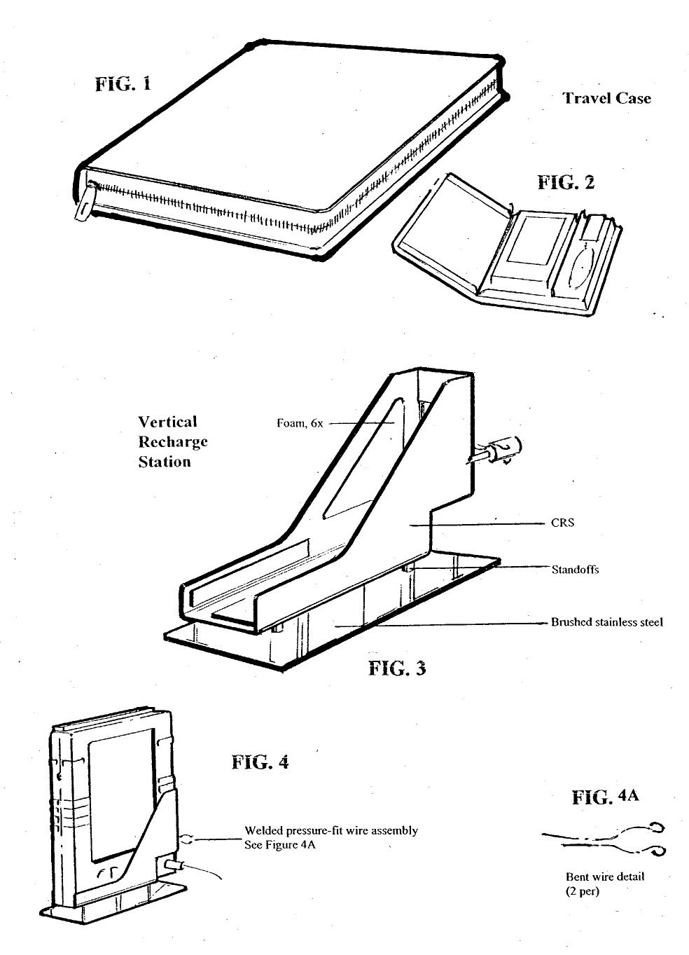

As a portable unit, any accessory that would help facilitate travel would obviously be important. FIG. 1 shows a suggested zipper-enclosure travel case. In the open position (FIG. 2), the DIDD can be placed inside along with the recharge cord/unit. Additional foam pads may be needed on the inside to prevent oscillation (movement) of the units while travelling. Materials suggested for this option are a tight-weave nylon outer shell with an inner sheet of thin, heat-formed, ABS.

FIG. 3 also shows an option for permanent use in the home. The “Vertical Recharge Station” takes advantage of the invention's album/book verticality and gives it a stable foundation (FIG. 4). This can be placed on the television, on a desk or even a bookshelf. A unique feature is the side clip (FIG. 4A), which is formed from two pieces of wire, welded closely together, to form a pressure fit for the recharge cord shown in FIG. 4.

FIG. 3 shows adhesive-backed foam placed on the inside to protect the DIDD during insertion. The Vertical Recharge Station is made of 0.06″ CRS, this is a very stable, weighted base for the invention. The bottom plate is 0.06″ brushed stainless steel. It supports the CRS above by 632 standoffs. Of course, counter-sunk screws will be used to secure the assembly.

The Invention (Recharge Cord/unit)

The recharge device will be between the requirements of a cellular phone and a laptop. The male recharge connector end will be received by the female end on the DIDD (refer to FIG. 4). The recharge unit attached to the male connector's UL listed cord is an input 120V, output 20.0V, 4500 mA power supply, which plugs into a standard outlet (max. specs).

It should be noted that the LCD will exceed the recharge unit's output by 5V. To compensate for this and other voltage problems, the invention's PCB design will store and perhaps amplify the voltage to appropriate levels.

The Invention (DIDD)

Software/Hardware

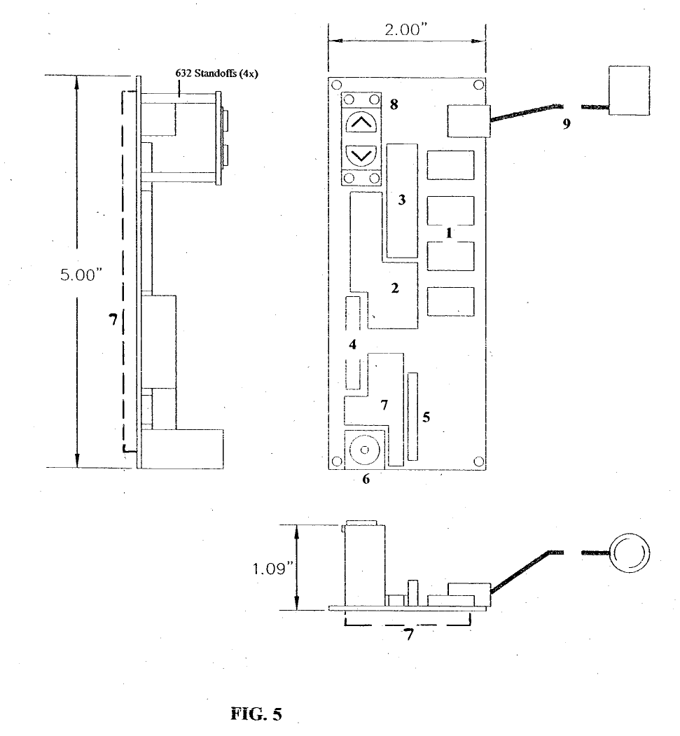

The software will be a hard program, directly encoded onto a logic chip set (see FIG. 5, no. 2). The program only need be compatible with IBM components. Generally, the software capabilities will be analogous to the DVD player/DVD screen products that are currently available in Sport Utility Vehicles (SUVs). Below outlines the PCB's capabilities in relationship to software and hardware:

A) Connection from the CD-ROM to the LCD. Once the CD is inserted, the power chip-CD-ROM relationship will be engaged (power on), LCD will then illuminate, showing the first image on the CD-R. Specifically, once the power chip set has done its job, the principal relationship will be from the CD-ROM to the PCB RAM. Once the CD-R's photo image is within RAM it will then be routed to the video chip and then up to the LCD.

B) Invention will display the CD-R's images individually (using 8-24 MB of RAM) without manipulation. End user will not be able to alter the displayed image. End user will be able to manipulate the images forward and back on the LCD by the use of 2 touch pad scroll keys. Principal relationship: touch pad-logic-video.

C) Able to output LCD image to external female connector on chassis. Principal relationship: touch pad-logic-video-output.

D) Power off. Essentially, when one pushes the eject button on the CD-ROM, the power will turn off. It is acknowledged that the power chip set will have to have a direct connection with the inject/eject mechanical movement of the CD-ROM. A power switch may have to be created within the selected CD-ROM. Once the CD is ejected, the switch disconnects the power, turning the entire unit off. Principal relationship: CD-ROM-power chip set.

PCB

A general real estate layout for the PCB is shown in FIG. 5. Hardware itemization:

1) 8-24 MB of RAM.

2) Logic chip (software).

3) Video chip (LCD-output).

4) LCD flex cable connector.

5) Pin connector for the CD-ROM.

6) Female recharge connector.

7) Power chip/battery set. (Has ability to shut-off once charged.)

8) 2^{nd} level PCB for touch pad (forward/back).

9) Output connector (tv).

PCB will be 2″×5″(max.)×0.06″ in size. This is an estimated quantity of “real estate” that will be necessary for the hardware/software function of the DIDD. It should be noted that this PCB will be on standoffs, therefore additional real estate can be used on the backside for additional hardware/traces/battery. Price quoted was for a 4 layer board. It is highly probable that a 2 layer board will suffice. All hardware components will be IBM based. Initial quantities will dictate an “engineering” lot.

The touch pad (forward/back keys) will be mounted on a 0.5″×1.1″×0.06″ PCB. The touch pad itself will have forward/back keys that resemble illuminated cell phone controls (neoprene or similar). See FIG. 5 (8) for a preliminary layout and side views. As noted on the side view, the PCB is on standoffs (approx. 0.95″ length) that are connected to the larger PCB. Assembly is by machine screws. Wiring from this PCB will of course will be free from the bottom and connect to the trace(s) and/or chip below. Voltage will be low enough so that electromagnetic interference shouldn't be a problem.

Component Architecture

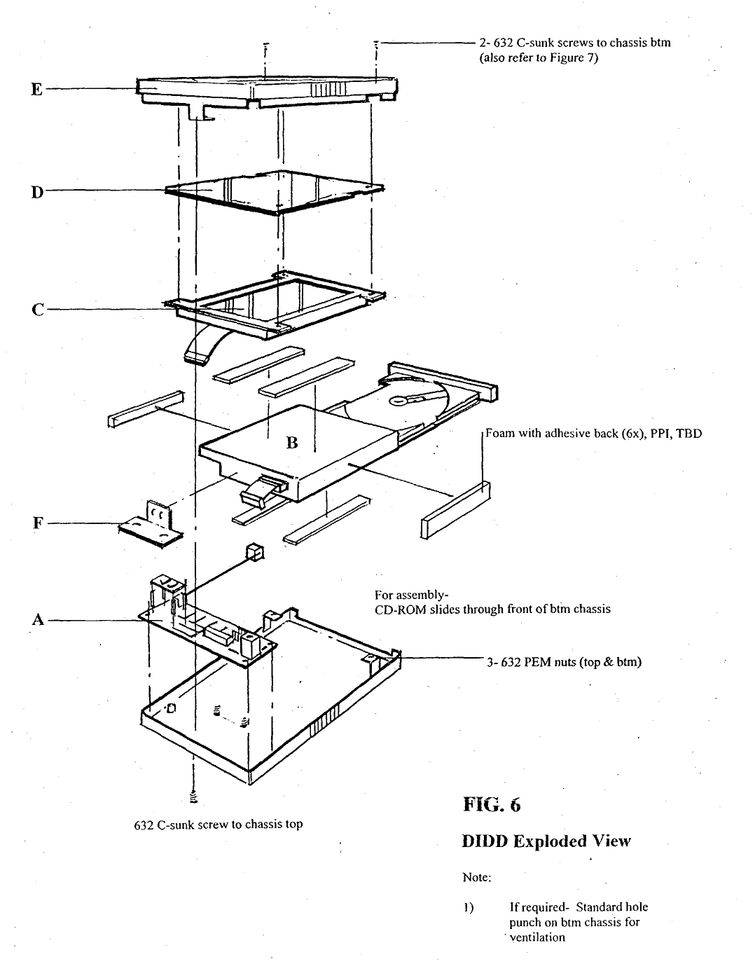

FIG. 6 shows an exploded view of the basic ingredients which comprise the DIDD. Outlining the components from the chassis' bottom up:

A) PCB (see above)

B) CD-ROM (laptop type). Understandably, the exact configuration and specs cannot be chosen until the time of production. Cost and quantities will govern purchase of unit. I feel comfortable specifying CD-ROMs as opposed to other drives. Noted author Peter Norton projected in '99 that these drives will have a 20 year cycle. Starting their shelf life in the early '90s, it reasonable that this simple drive will be around until the early '10s. Simple technology, the need to just read an image on the CD-R, and ample quantities were the reasons for choosing this component.

Rear mounting will be provided by a separate flange (F). It will be a 632 nut-threaded insert assembly. Top is pressure-fitted with PPI-rated foam from the underside of the LCD. Sides are also “mounted” with the use of foam. Final mounting configuration of course will depend on the future CD-ROM. Typical connections for this component are IDE/ATAPI or SCSI. The final hardware/component spec for the PCB will dictate which type of connector to use. IEEE 1394 specs may also be an option for the component interface to the PCB controller (logic chip). Product is a Class 1 laser. Of course, IBM interface. Related Patents: U.S. Pat. Nos. 5,067,128/4,575,835/4,937,803/4,955,010.

C) Transreflective, low voltage, TFT, LCD. Image size is 4×6. Again, this is a component that will have to be bought according to market quantities/cost at the time of production. I am hopeful of an easily purchased 4×6 image size, but it is not critical. I am also hopeful that a color PDA-type LCD will be cost-effective enough to be used in the DIDD. Recommended power for a typical black and white (blue/green background) unit is 25V (see 0032). Black and white unit is an IBM interface via flex cable.

D) Clear, non-glare, 0.06″ acrylic lens for the LCD.

E) Chassis top. This will be made of approx. 0.06″ 5150 aluminum (or equivalent). The threaded inserts for the assembly of the 0.06″ acrylic lens/LCD will be stainless (electrolysis consideration). Exact configuration of the inserts will depend on the LCD chosen at the time of production. Counter-sunk screws will be used on the outside to secure the top and bottom of the chassis. See exploded view for preliminary configuration.

Chassis bottom. Standoffs for the PCB will be 0.25″ in length and stainless. Pressure-fit foam strips have been chosen for the CD-ROM side/top/bottom mounts (refer to 0044). PPI specs for the foam will be based future impact tests.

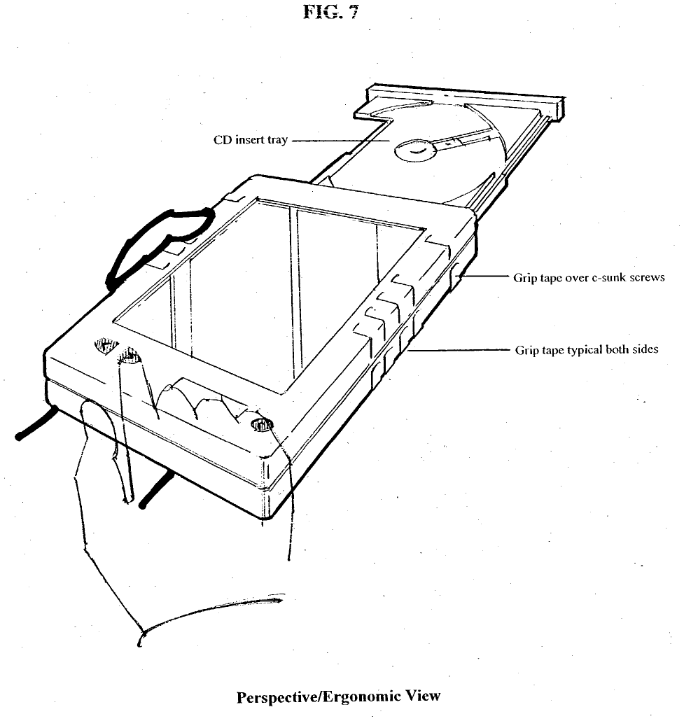

The entire chassis will be black powder coated (except at threaded/foam/grip tape areas; see FIGS. 6 and 7). Coverage will be sufficient so as to not cause any electromagnetic interference. Initial production run will be low in quantity; therefore a sheetmetal shop will suffice for quantities up to 1000. Overall dimensions are approximately 1.5″×8.3″×5.4″ (see Appendix).

The perspective shown below (FIG. 7) shows how small the DIDD is in relationship to the hand.

Appendix

Mechanical Design Drawings—

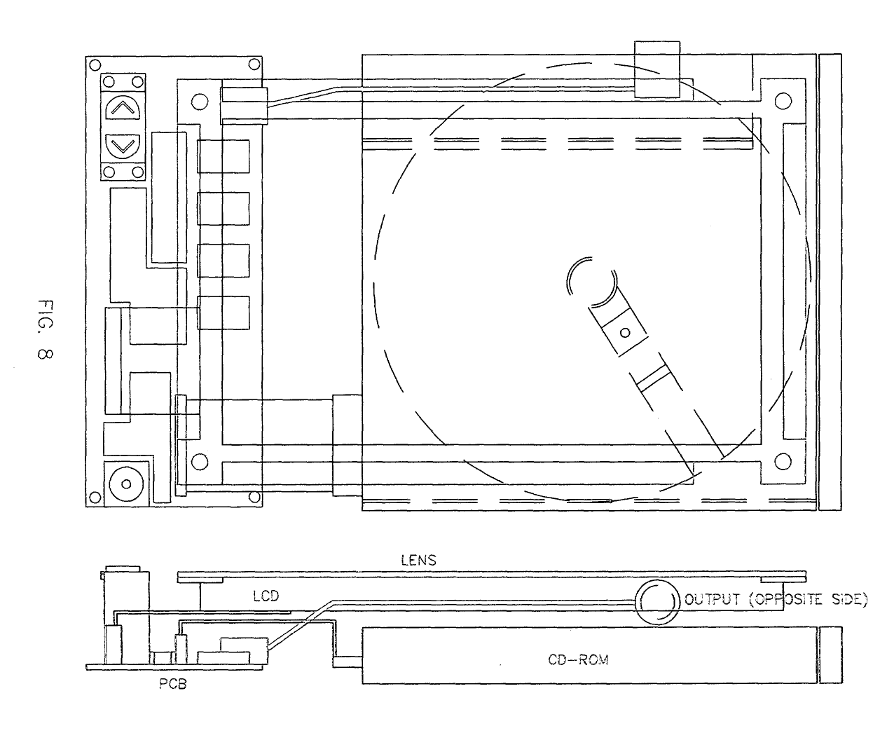

FIG. 8 cad component layout (scaled to fit)

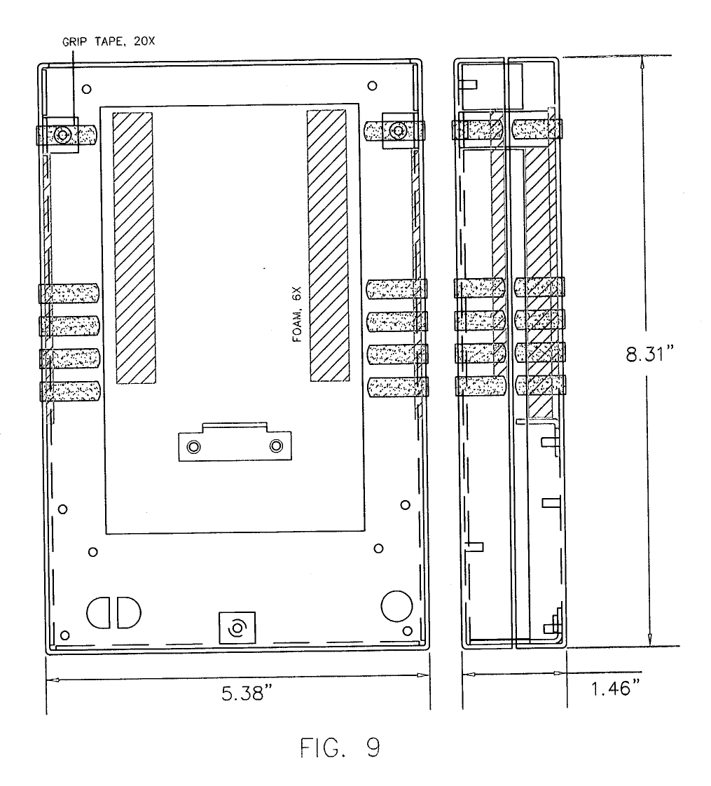

FIG. 9 cad packaging layout (scaled to fit)

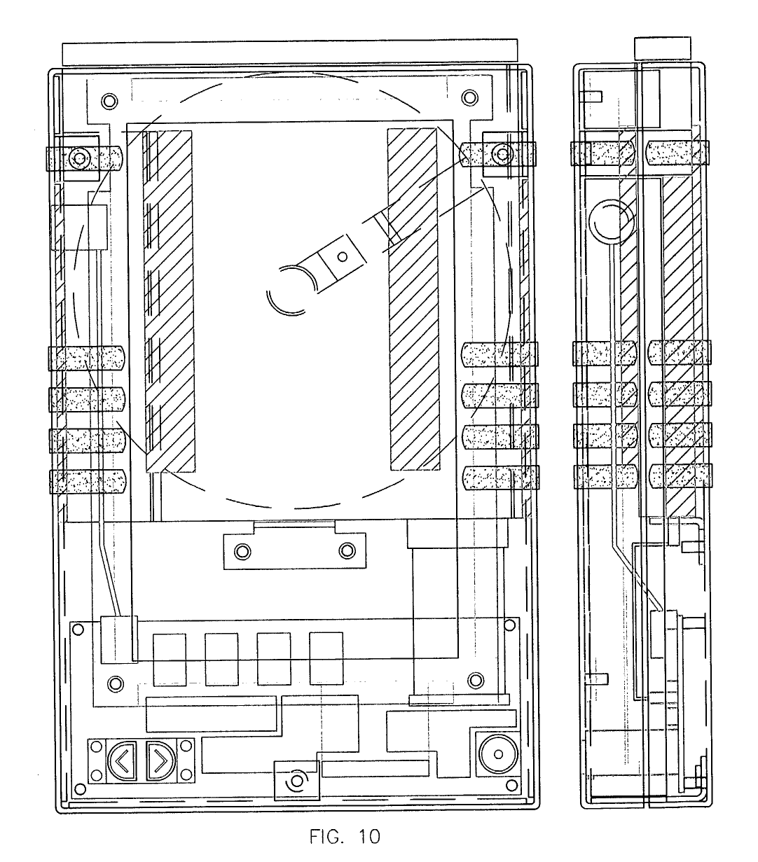

FIG. 10 cad overall layout (scaled to fit)

I claim:

1) using existing personal computer components, construct a hand-held device which displays commonly-formatted, digital images stored on an inserted compact disc (CD).

2) That claim 1 is a rechargeable device using existing electrical components.

3) That claim 1 is simple to operate by the use of two “touch pad” scroll keys for a forward and back display of each digital image on the inserted compact disc.

4) That claim 1 has an output receptacle for a television set using existing electrical/video/electronic components.

5) That the invention is comparable in price to a Personal Digital Assistant.
